(19) United States
(12) Patent Application Publication
(10) Pub. No.: US 2002/0145765 A1
(43) Pub. Date: Oct. 10, 2002

(54) Method and apparatus for increasing scan resolution

(76) Inventor: Huil-ing Chou, Hsinchu (TW)

Correspondence Address: BACON & THOMAS, PLLC, 625 Slaters Lane, 4th Floor, Alexandria, VA, 22314-1176, US

(21) Appl. No.: 09/824,792

(22) Filed: Apr. 4, 2001

(51) Int. Cl. H04N 1/04; H04N 1/46

(52) U.S. Cl. 358/474; 358/528

(57) ABSTRACT

A method and apparatus for increasing scan resolution without varying scanner hardware specifications is disclosed. In one embodiment, a pre-scan operation is firstly performed in order to provide information for scan ranges and resolutions selections. When the data quantum of the selected scan range accompanied with resolution is still held by scanner hardware, scan operations will be performed according to selected ones. If the data quantum arisen from the selected ones is higher than scanner hardware threshold, the highest scan resolution of the scanner hardware will be employed to scan selected scan ranges. Interpolations are then performed to the scanned images for increasing scan resolution to selected one before displaying to individuals.

### BACKGROUND OF THE INVENTION

1. Field of the Invention

The present invention relates to a method and apparatus for increasing scan resolution. More specifically, the present invention relates to a method and apparatus for increasing scan resolution without varying scanner hardware specifications.

2. Description of the Prior Art

Advancements in electrical engineering allow the functions and performances of computer peripheral devices to be unceasingly multiplied. For example, the manufacturers of scanners have to continuously upgrade resolutions and color display performances of their products. However, they should have to make their scanners to be capable of activating a printer for copying scanned images or starting a facsimile machine for faxing scanned images to indicated destinations. Also due to the simplifications to operations for modem scanners, scanner manufacturers endeavor to make their scanners to be information appliances in the future.

In order to decrease manufacturing costs, scanner manufacturers usually construct their scanners by using low-end components. Therefore, scanner hardware, e.g., application specific integrated circuit (ASIC), may only manipulate data quantum equal to or even less than 16 KB. However, modem scanners usually support different scan resolutions for scanning document sheets, which implies that data quantum (e.g., pixels) the ASIC should manipulate may be higher than hardware threshold, in other words, the data quantum is too large to hold by scanner hardware. For example, when an individual put a document sheet of FIG. 1A for scanning, scanner may display FIG. 1B or 1C for scan range or resolution selections if the data quantum that is going to be manipulated is higher than hardware threshold. Obviously, right-most region 102 of the document sheet disappears in FIG. 1B, whereas both regions 104A and 104B have vanished in FIG. 1C. Such discontinuous visual effects may confuse individual when operating. In order to overcome the aforementioned drawbacks, scanners, especially those low-end scanners, usually request individuals to put their document sheets at centrals or specific positions of their transparent windows for obtaining acceptable scan result. There is a need to disclosed an apparatus accompanied with operating method that scanners may derive scanned images without having to vary their hardware specifications for eliminating disadvantages mentioned above.

### SUMMARY OF THE INVENTION

The principal object of the invention is to provide a method and apparatus for performing scan operations based on scan ranges and resolutions selected by individuals without varying scanner hardware specifications.

In one embodiment, an individual may select required scan range and resolution after pre-scan operation completes. When the data quantum of the selected scan range accompanied with resolution is still held by scanner hardware, scan operations will be performed according to selected ones. Scanned images are then displayed to individuals. If the data quantum of the selected scan range accompanied with resolution is higher than the threshold of the scanner hardware, the highest scan resolution of the scanner hardware will be employed to scan the selected scan ranges. Interpolations are then performed to the scanned images to increase scan resolution to be selected one before displaying to individuals.

In the embodiment, a scanner resident module is disclosed to provide computer executable instructions or programs executed by processor or processors of a computer host, wherein the computer host electrically coupled with the scanner via a connection. Scan resident module basically encompasses an interpolation program module, a data quantum determination module, and a user interface resource module. Interpolation program module stores computer instructions for performing interpolations to scanned images. Data quantum stores computer instructions for determining whether data quantum is higher than hardware threshold based on selected scan ranges and resolution. User interface resource module stores resource codes illustrative of graphics, icons, or any kind of viewable objects. Processor or processors of the computer host may execute the computer instructions to perform required operations or display viewable objects.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is an exemplary diagram of a document sheet;

FIG. 1B is a first exemplary diagram for showing portions of the pre-scan image derived from FIG. 1A conventionally;

FIG. 1C is the second exemplary diagram for showing portions of the pre-scan image derived from FIG. 1A conventionally;

FIG. 2 is a flowchart for representing operating sequences according to the embodiment;

FIG. 3 is a schematic diagram according to the embodiment; and

FIG. 4 is a diagram illustrative of software module configuration according to the embodiment.

### DESCRIPTION OF THE PREFERRED EMBODIMENT

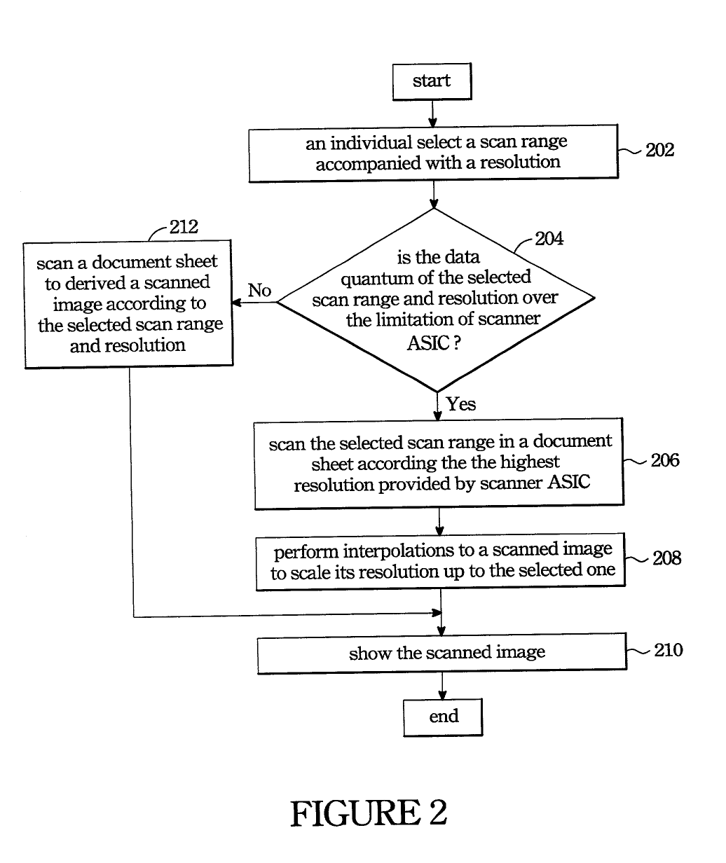

FIG. 2 shows a flowchart illustrative of the operating sequences according to the embodiment. Firstly, a scanner perform pre-scan to a document sheet to obtain pre-scan image including its range and size, this pre-scan image is then displayed in a user interface or an operating interface that is provided for an individual for scan range and resolution selections or indications (step 202). The above user or operating interface is shown in display device of a computer host that couples with the scanner. The scanner determines whether the data quantum (e.g., pixel numbers) arisen from the selected scan range and resolution is higher than a limitation or threshold of the scan hardware (e.g., ASIC) (step 204). If the data quantum is higher than the threshold, the highest scan resolution supported by the scanner is employed to scan the selected scan range of the document sheet (step 206). Interpolation is then performed to the scanned image so that the scan resolution will be increased to the selected one (step 208). The image derived by means of interpolation is finally displayed to individual for viewing (step 210). On the other hand, when the data quantum is not higher than the hardware threshold (limitation), scan operations to the selected scan range by means of the selected scan resolution to generate a scanned image (step 212). The obtained scanned image is finally displayed to individual (step 210).

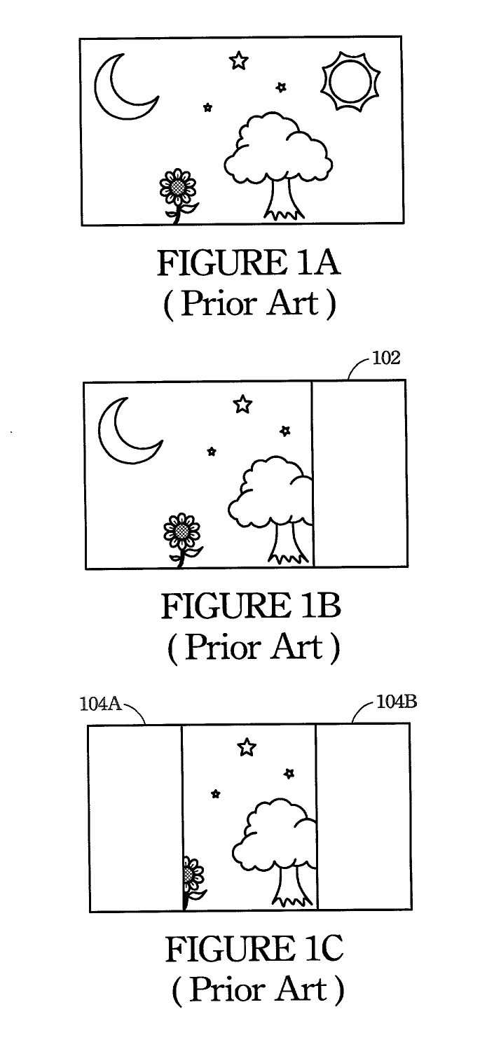

Notably, whole the document sheet is shown to individual for scan range and resolution selections in step 202, whereas portions of pre-scan images in FIGS. 1B and 1C are shown for selections in conventional approach. In step 204, highest scan resolution (300, 600, 1200, or 20400 dpi (dot-per-inch)) provided by scanner image sensor (e.g., CCD, CIS, or CMOS sensor), bytes for color illustration to each pixel (e.g., RGB system), and the scan range selected by individual (which will determine image size) are used for data quantum computation or determination. In step 208, any conventional interpolating scheme, such as bilinear, bicubic, or any algorithm used for image interpolation may be employed in the embodiment.

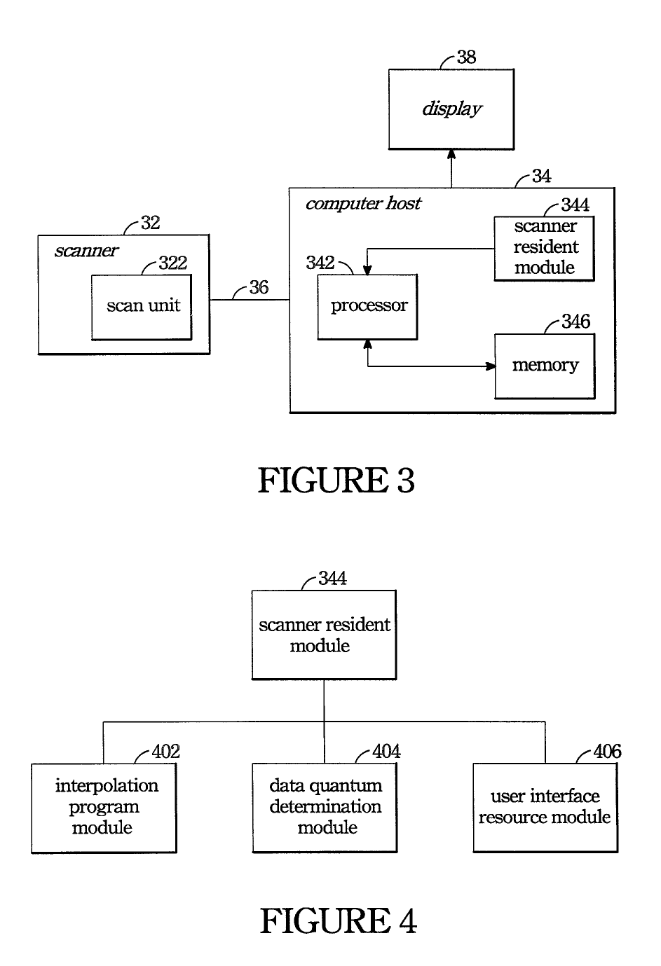

Please next refer to FIG. 3, a schematic diagram of the embodiment is shown therein, which basically encompasses scanner 32 and computer host 34 that are electrically coupled via connection 36 for data transmission. For example, scanner 32 may transfer scanned image to computer host 34, and computer host 34 may detect current status of scanner 32 (e.g., whether scanner 32 normally works). Additionally, computer host 34 couples with a display 38 for displaying operating interfaces and scanned images for viewing. Scanner 32 basically contains a scan unit 322 for performing scan operations (including pre-scan operations), which may further include an image sensor such as CCD (Charge coupled device), CIS (Contact image sensor), or COMS sensor, hardware (e.g., ASIC) for manipulating light-electron conversions and for generating scanned images. Compute host 34 basically includes a processor 342, scanner resident module 344, and memory 346. Processor 342 executes computer instructions or programs provided by scanner resident module 344 to perform data quantum determination, image interpolation, and display operating interfaces for selections. Memory 346 stores temporary data or information generated by processor 342 such as optical signals (which will be delivered to display 38) used for displaying to individual.

FIG. 4 shows software module configuration of scanner resident module 344, which basically includes interpolation program module 402, data quantum determination module 404, and user interface resource module 406. Interpolation program module 402 stores computer executable instructions or programs for performing interpolations to scanned images. Data quantum determination module 404 stores computer instructions or programs for determining whether the data quantum that is going to be processed is higher than hardware threshold based on selected scan range and resolution. User interface resource module 406 stores resource codes or programs for illustrating graphics, icons, or any kind of resources used for displaying viewable objects. Processor 342 (may include at least one processors) executes the above computer instructions or programs to perform or activate required functions and displays images or associated operating interfaces for scan range and resolution selections. Notably, scanner resident module 344 may be included in scanner drivers to encapsulate computer instructions or programs included therein may be stored in any kind of computer-readable storage medium, for example, portable storage medium such as compact discs (CDs), floppy disks, or magnetic optical disks. Therefore, scanner drivers (which contain scanner resident module 344) may be stored in hard disk of computer host 34 after installation. Any ordinary person who is skilled in the art associated with the present invention should modify the embodiment as specifications or applications.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for increasing scan resolution without varying hardware specification, said method comprising the steps of:
obtaining a data quantum based on an indicated scan range and an indicated scan resolution;
when said data quantum is higher than a threshold of scanner hardware, generating a scanned image of said indicated scan range by using a highest resolution provided by an image sensor; and
performing an interpolation to said scanned image for increasing resolution of said scanned image to said indicated scan resolution.

2. The method according to claim 1, further comprising a step of performing a scan operation to said indicated scan range when said data quantum is not higher than said threshold.

3. The method according to claim 1, said data quantum being determined by using said highest resolution provided by said image sensor, bytes for color illustrations to each pixel, and said indicated scan range.

4. The method according to claim 1, said image sensor being a charge coupled device, a contact image sensor, or a CMOS sensor.

5. The method according to claim 1, said interpolation being performed by using bilinear or bicubic algorithm.

6. The method according to claim 1, further comprising a pre-scan step for generating a pre-scan image of a document sheet used for selections to said indicated scan range and said indicated scan resolution.

7. A computer-readable storage medium for storing a method for increasing scan resolution without varying scanner hardware specifications, said computer-readable storage medium having computer executable instructions for performing steps comprising:
obtaining a data quantum based on an indicated scan range and an indicated scan resolution;
when said data quantum is higher than a threshold of scanner hardware, generating a scanned image of said indicated scan range by using a highest resolution provided by an image sensor; and
performing an interpolation to said scanned image for increasing resolution of said scanned image to said indicated scan resolution.

8. The computer-readable storage medium according to claim 7 comprising:
an interpolation program module for storing computer executable instructions for performing said interpolation;
data quantum determination module for storing computer executable instructions for determining said data quantum; and
user interface resource module for storing resource codes used by operating interfaces, wherein said operating interfaces are displayed for selections to said indicated scan range and said indicated scan resolution.

9. The computer-readable storage medium according to claim 7, further comprising computer executable instructions for performing scan operations to said indicated scan range by using said indicated scan resolution when said data quantum is not higher than said threshold.

10. The computer-readable storage medium according to claim 7, said data quantum being determined by using said highest resolution provided by said image sensor, bytes for color illustrations to each pixel, and said indicated scan range.

11. The computer-readable storage medium according to claim 7, said image sensor being a charge coupled device, a contact image sensor, or a CMOS sensor.

12. The computer-readable storage medium according to claim 7, said interpolation being performed by using bilinear or bicubic algorithm.

13. The computer-readable storage medium according to claim 7, further comprising computer executable instructions for generating a pre-scan image of a document sheet used for selections to said indicated scan range and said indicated scan resolution.

14. A scanner electrically coupled with a computer host that may generate scanned images having scan resolutions higher than a highest scan resolution provided by said an image sensor of said scanner without varying scanner hardware specification, said scanner comprising:
scan unit for generating a scanned image; and
scanner resident module for storing computer executable instructions comprising:
an interpolation program module for storing computer executable instructions for performing image interpolations;
data quantum determination module for storing computer executable instructions for determining a data quantum that is going to be processed; and
user interface resource module for storing resource codes used by operating interfaces, wherein said operating interfaces are displayed for selections to an indicated scan range and an indicated scan resolution;
wherein a processor of said computer host executes said computer executable instructions of said data quantum determination module to determine whether said data quantum arisen by said indicated scan range and indicated scan resolution is higher than a threshold of scanner hardware, said processor executing said computer executable instructions of said interpolation program module to perform interpolation to a scanned image for increasing a scan resolution of said scanned image to said indicated scan resolution.

15. The scanner according to claim 14, said scanned image that is interpolated being generated by using a highest scan resolution provided by said image sensor to said indicated scan range.

16. The scanner according to claim 14, said scan unit performing a scan operation to said indicated scan range by using said indicated scan resolution when said data quantum is not higher than said threshold.

17. The scanner according to claim 14, said data quantum being determined by using said highest resolution provided by said image sensor, bytes for color illustrations to each pixel, and said indicated scan range.

18. The scanner according to claim 14, said image sensor being a charge coupled device, a contact image sensor, or a CMOS sensor.

19. The scanner according to claim 14, said interpolation being performed by using bilinear or bicubic algorithm.

20. The scanner according to claim 14, said scan unit performing a pre-scan operation for generating a pre-scan image of a document sheet used for selections to said indicated scan range and said indicated scan resolution.
